(19) United States
(12) Patent Application Publication
(10) Pub. No.: US 2025/0188791 A1
(43) Pub. Date: Jun. 12, 2025

(54) ROBOT TRAVERSAL METHOD, AND ROBOT

(71) Applicant: SHENZHEN PUDU TECHNOLOGY CO., LTD., Shenzhen, Guangdong (CN)

(72) Inventors: Yi YUAN, Shenzhen (CN); Hanrong CHEN, Shenzhen (CN); Zhouyu WU, Shenzhen (CN); Yongsheng ZHANG, Shenzhen (CN); Shicheng LIN, Shenzhen (CN); Junan ZHU, Shenzhen (CN)

(21) Appl. No.: 18/841,219

(22) PCT Filed: Apr. 28, 2023
(86) PCT No.: PCT/CN2023/091454

§ 371 Date: Aug. 23, 2024

(30) Foreign Application Priority Data
Apr. 29, 2022 (CN) 202210468517.8
May 6, 2022 (CN) 202210487957.8
Apr. 11, 2023 (CN) 202310415442.1

(51) Int. Cl. E05F 15/77; G05D 1/646

(52) U.S. Cl. CPC E05F 15/77; G05D 1/646; E05Y 2400/446

(57) ABSTRACT

A robot traversal method includes: when a target robot travels to a transition area, determining a present door corresponding to the target robot in the transition area; and controlling the present door to be opened and passing through the present door.

### CROSS-REFERENCE TO RELATED APPLICATIONS

The present application is a national stage application of PCT international application No. PCT/CN2023/091454 filed on Apr. 28, 2023, which claims priority to Chinese patent application No. 202210468517.8, filed on Apr. 29, 2022, and entitled ‘METHOD AND DEVICE FOR ROBOT TO PASS THROUGH GATE, AND COMPUTER DEVICE’, claims priority to Chinese patent application No. 202210487957.8, filed on May 6, 2022, and entitled ‘METHOD FOR CONTROLLING MOVEMENT OF SELF-MOVING DEVICE, SELF-MOVING DEVICE, AND STORAGE MEDIUM’, and claims priority to Chinese patent application No. 2023104154421, filed on Apr. 11, 2023, and entitled ‘METHOD AND DEVICE FOR PASSING THROUGH MULTIPLE LEVELS OF DOORS, ROBOT, AND STORAGE MEDIUM’, the entire contents of which are incorporated herein by reference.

### TECHNICAL FIELD

The present disclosure relates to the field of automation technology, and in particular, to a robot traversal method and a robot.

### BACKGROUND

With the development of automation technology, various smart devices have emerged, bringing great convenience to people's lives and work. Robots are one of the most important smart devices.

In conventional technology, at least one door is usually installed in a passage with partition requirements to partition the passage. When multiple robots need to pass through the passage, congestion often occurs, resulting in low efficiency of robot access.

### SUMMARY

According to various embodiments of the present disclosure, a robot traversal method and a robot are provided.

The robot traversal method is applied to a target robot. The target robot is any robot among multiple robots that need to pass through a transition area. The method includes:
determining, when the target robot travels to the transition area, a present door corresponding to the target robot in the transition area; and
controlling the present door to be opened and passing through the present door.

A robot includes a memory and a processor. The memory stores a computer program, and the processor is configured to implement the steps of the above-mentioned robot traversal method when executing the computer program.

A computer-readable storage medium stores a computer program, which implements the steps of the above-mentioned robot traversal method when executed by a processor.

A computer program product includes a computer program. When the computer program is executed by a processor, the steps of the above-mentioned robot traversal method are implemented.

Details of one or more embodiments of the present disclosure are set forth in the accompanying drawings and the description below. Other features and advantages of the disclosure will be apparent from the description, drawings, and claims.

### BRIEF DESCRIPTION OF THE DRAWINGS

To describe the technical solutions in the embodiments of the present disclosure or the prior art more clearly, the following briefly describes the accompanying drawings required for describing the embodiments or the prior art. Apparently, the accompanying drawings in the following description show merely some embodiments of this application, and a person of ordinary skill in the art may derive other drawings from these accompanying drawings without creative efforts.

FIG. 1 is a schematic diagram of an application environment of a robot traversal method according to an embodiment;

FIG. 2 is a flow chart of a robot traversal method according to an embodiment;

FIG. 3 is a flow chart of passing through a present door according to an embodiment;

FIG. 4 is a schematic diagram of a system architecture of a robot traversal method according to an embodiment;

FIG. 5 is a schematic diagram showing an effect of multiple robots passing through a transition area according to an embodiment;

FIG. 6 is a schematic diagram showing a positional relationship between a present door, a forward door, and a back door according to an embodiment;

FIG. 7 is a schematic diagram showing an effect of a relative position relationship between multiple robots according to an embodiment;

FIG. 8 is a flow chart of a robot traversal method according to another embodiment;

FIG. 9 is a schematic diagram of a transition area according to an embodiment;

FIG. 10 is a schematic diagram of robots traveling in one direction and one way according to an embodiment;

FIG. 11 is a schematic diagram of a transition sub-area according to an embodiment;

FIG. 12 is a flow chart of a robot passing through multiple levels of doors according to an embodiment;

FIG. 13 is a schematic diagram of robots traveling in one direction and two ways according to an embodiment;

FIG. 14 is a schematic diagram of robots traveling in two directions and one way according to an embodiment;

FIG. 15 is a flow chart of passive equipment passing through multiple levels of doors according to an embodiment;

FIG. 16 is a flow chart of active equipment passing through multiple levels of doors according to an embodiment; and

FIG. 17 is a schematic diagram of an internal structure of a computer device according to an embodiment.

### DETAILED DESCRIPTION OF THE EMBODIMENTS

In order to facilitate understanding of the present disclosure, the present disclosure will be described more fully below with reference to the relevant drawings. Preferred embodiments of the present disclosure are illustrated in the accompanying drawings. However, the disclosure can be implemented in many different forms and is not limited to the embodiments described herein. On the contrary, these embodiments are provided so that a thorough understanding of the present disclosure will be provided.

Unless otherwise defined, all technical and scientific terms used herein have the same meaning as commonly understood by one of ordinary skill in the technical field to which the present disclosure belongs. The terms used herein in the description of the present disclosure are for the purpose of describing specific embodiments only and are not intended to limit the disclosure. As used herein, the term ‘and/or’ includes any combinations of one or more of the associated listed items.

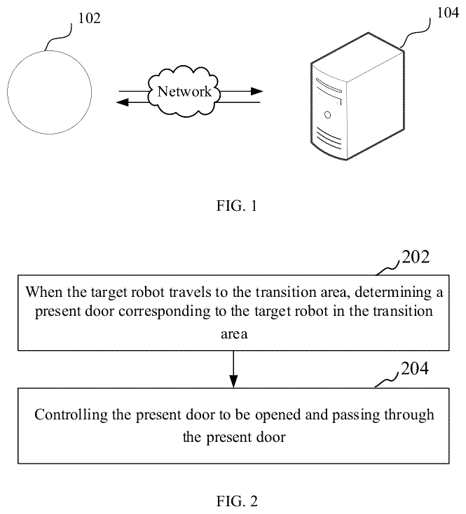

A robot traversal method provided by the embodiments of the present disclosure can be applied in an application environment as shown in FIG. 1. In the application environment, a device 102 communicates with a server 104 through a network. The device 102 can be a robot or a control device, such as a robot digital processor. The robot digital processor can be integrated in a robot, and the control device controls various robots in a transition area. The server 104 can be implemented as an independent server or a server cluster composed of multiple servers. A data storage system can store the data that the server 104 needs to process. The data storage system can be integrated on the server 104, or placed on the cloud or other network servers. Both the device 102 and server 104 can be used individually to perform the robot traversal method provided in the embodiments of the present disclosure. The device 102 and server 104 can also be used collaboratively to perform the robot traversal method provided in the embodiments of the present disclosure. The device 102 can be, but is not limited to, at least one of various self-moving devices, robots, self-driving cars, unmanned aircraft, etc. The robot can be a smart device that perform various functions through self-moving, such as a cleaning robot, a delivery robot, a logistics robot, a disinfection robot, etc. The present disclosure will be described with the device 102 being a robot. The robot can perform the robot traversal method in the present disclosure independently, or it can cooperate with a server or other robots to perform the robot traversal method in the present disclosure.

In an embodiment, as shown in FIG. 2, a robot traversal method is provided. Taking the application of the method to a target robot as an example, the method includes step 202 and step 204.

In step 202, when the target robot travels to a transition area, a present door corresponding to the target robot in the transition area is determined.

The transition area refers to a passage connecting a first area and a second area, and at least one door is provided in the transition area. In a possible embodiment, the first area is an isolation area, and the second area is the outside. The present door refers to the first door that the target robot presently needs to pass through, which can be understood as the door closest to the target robot in the traveling direction of the target robot. The door can be a gate.

Exemplarily, when the target robot obtains position information thereof and determines, based on the position information, that the target robot has moved to the transition area, installation position information of each door in the transition area is obtained, and the present door corresponding to the target robot is determined based on the position information and the installation position information of each door.

In step 204, the present door is controlled to be opened and the present door is passed through.

Exemplarily, the target robot sends an open instruction to a door control system, the door control system opens the present door, and the target robot passes through the present door. The door control system can also include a door control device or a door control unit for controlling the door to be opened or to be closed. For example, the door control system can be a door control device that jointly controls each door of multiple levels of doors, i.e., the multiple levels of doors can be controlled by one door control system. Alternatively, the door control system can include door control units corresponding to the respective doors. The door control system can be independent of the door or can be set in the door. In an embodiment, the door control system can be a gate machine, which receives a gate opening instruction and controls the gate to be opened or to be closed. The open instruction can be a gate opening instruction, which is configured to instruct the door to open, or to instruct to open the gate.

In this embodiment, when the target robot travels to the transition area, the present door corresponding to the target robot is first determined, and then the present door is controlled to be opened and the target robot passes through the present door.

In an embodiment, controlling the present door to be opened and passing through the present door includes the following steps 302 to 310.

In step 302, traveling state information of the target robot is obtained. The traveling state information includes traveling speed information and pose information.

The traveling state information of the target robot includes the traveling speed information and the pose information of the robot. Exemplarily, the pose information includes traveling direction information and positioning information of the robot.

Exemplarily, the target robot obtains its traveling speed information through a speed sensor on the target robot, and can also obtain its positioning information and traveling direction information in real time through a positioning chip of the target robot.

In step 304, a deceleration area is determined based on a target map of the target robot, the traveling speed information and the pose information, and a buffer area is determined based on the deceleration area.

The target map of the target robot can be a travelable path map, which specifies the traveling area of all running robots, and the target map is composed of multiple travelable paths. The travelable path of the target robot refers to the possible travel route of the target robot planned in the target map. The target map is stored in each robot.

The deceleration area is an area where the target robot reduces its present speed to a preset speed. The buffer area is an area where the target robot establishes a connection channel with the door control system.

For example, the target robot extracts the traveling speed and traveling direction of the target robot from the traveling state information obtained in step 302. Firstly, the target robot calculates a deceleration distance of the deceleration area according to the traveling speed of the target robot, then selects a deceleration start line on the travelable path of the target robot, and determines the deceleration area and an end line of the deceleration area according to the deceleration start line and deceleration distance. The end line of the deceleration area serves as a start line of the buffer area. The installation position information of the present door (the coordinates of the present door) is obtained from the target map. A straight line parallel to the horizontal axis and passing through the installation position information of the present door serves as an end line of the buffer area. The buffer area is determined based on the start line of the buffer area and the end line of the buffer area.

In step 306, when the target robot travels to the deceleration area, the target robot travels at a preset speed and sends a communication connection request to a door control system.

Exemplarily, the target robot obtains the positioning information of the target robot, and determines whether the target robot is located in the deceleration area based on the positioning information. When the target robot determines that the target robot is located in the deceleration area, it reduces the real-time speed of the target robot to the preset speed with a certain acceleration and, within the deceleration area, continuously sends the communication connection request to the door control system.

In step 308, when the target robot travels to the buffer area, a communication connection result between the target robot and the door control system is obtained. An open instruction is sent to the door control system based on the communication connection result so as to cause the door control system to open the present door in response to receiving the open instruction.

The open instruction is configured to instruct the door control system to open the present door. The duration for which the door control system keeps the present door open can be set by an administrator.

Exemplarily, the target robot obtains the positioning information of the target robot, determines whether the target robot is located in the buffer area according to the positioning information, and then determines whether the target robot has established a connection channel with the door control system. If the target robot is already in the buffer area and has established a connection channel with the door control system, the target robot sends an open instruction to the door control system.

In step S310, the target robot passes through the present door.

Exemplarily, the door control system opens the present door in response to receiving the open instruction sent by the target robot, and the target robot passes through the opened present door at the preset speed.

In this embodiment, the target robot obtains the traveling speed information and the pose information of the target robot, determines the deceleration area according to the target map, the traveling speed information and the pose information of the target robot, and determines the buffer area according to the deceleration area. When the target robot travels to the deceleration area, the target robot travels at a preset speed and sends a communication connection request to the door control system. When the target robot travels to the buffer area and the target robot has established a connection channel with the door control system, the target robot sends an open instruction to the door control system and passes through the present door. According to this method, the buffer area and the deceleration area for the target robot near the door control system are determined, the speed of the target robot is reduced to a preset speed in the deceleration area, and within the buffer area, an open instruction is sent to the door control system, allowing the target robot to pass through the present door at the preset speed, thereby enabling the target robot to pass through the present door smoothly.

In an embodiment, determining the deceleration area according to the target map, the traveling speed information, and the position information of the target robot includes the following steps 402 to 406.

In step 402, a travelable path of the target robot is obtained from the target map, and a start line of the deceleration area is determined from the travelable path of the target robot.

The target map can be a travelable path map, which is pre-stored in the target robot. The travelable path of the target robot is one of the travelable paths in the target map.

Determining the start line of the deceleration area includes: firstly, determining the preset speed of the target robot when it pass through the present door, then obtaining an average traveling speed and average braking acceleration of the target robot, calculating an average deceleration distance of the target robot according to the average traveling speed and average braking acceleration of the target robot, and then adding a preset distance to the average deceleration distance to obtain a first distance. The installation position information (coordinates) of the present door on the target map is obtained, the ordinate of the present door is taken as a start line, and the first distance from the start line is set as the start line of the deceleration area.

Exemplarily, the start line of the deceleration area is determined based on the installation position information of the present door obtained from the target map, the average speed and the average acceleration of the target robot.

In step 404, a deceleration distance is determined based on the traveling speed information.

Exemplarily, the present speed of the target robot is obtained from the traveling speed information of the target robot. The target robot obtains the braking acceleration of the target robot, calculates the deceleration time for the target robot to decelerate from the present speed to the preset speed based on the braking acceleration, and calculates the deceleration distance according to the deceleration time.

In step 406, the deceleration area is determined based on the pose information, the deceleration distance, and the start line of the deceleration area.

It can be understood that the target robot determines the line that is a deceleration distance away from the start line of the deceleration area in its traveling direction as the end line of the deceleration area, and then determines the area enclosed by the start line of the deceleration area and the end line of the deceleration area on the travelable path of the target robot as the deceleration area.

In this embodiment, the target robot determines the deceleration area based on the traveling direction of the target robot, the deceleration distance, and the start line of the deceleration area, enabling the target robot to pass through the present door at a preset speed, thereby preventing the goods carried by the target robot from falling due to a strong collision with the present door caused by the high speed at which the target robot passes through the present door.

In an embodiment, determining the buffer area based on the deceleration area includes the following steps 502 to 506.

In step 502, the end line of the deceleration area is extracted from the deceleration area, and the end line of the deceleration area serves as a start line of the buffer area.

Exemplarily, the end line of the deceleration area is extracted from the deceleration area, and the end line of the deceleration area serves as the start line of the buffer area.

In step 504, the installation position information of the present door is obtained from the target map, and an end line of the buffer area is determined based on the installation position information of the present door.

Exemplarily, the installation position information of the present door is obtained from the target map, and the vertical coordinate straight line of the installation position information of the present gate is taken as the end line of the buffer area.

In step 506, the buffer area is determined based on the start line of the buffer area and the end line of the buffer area.

Exemplarily, in the travelable path of the target robot, the area enclosed by the start line of the buffer area and the end line of the buffer area is determined as the buffer area.

In this embodiment, the buffer area is determined on the travelable path, and the buffer area is configured for the target robot to establish a connection channel with the door control system and send an open instruction to the door control system, ensuring that the door control system has received the open instruction sent by the target robot when the target robot reaches the present door, thereby allowing the target robot to pass through the present door smoothly.

In an embodiment, obtaining the traveling state information of the target robot includes the following steps.

In step 602, positioning information of the target robot is obtained.

Since the traveling state information of the target robot contains real-time positioning information of the target robot, the target robot needs to obtain the real-time positioning information of the target robot before decelerating.

The target robot traveling at the preset speed and sending the communication connection request to the door control system when the target robot travels to the deceleration area includes the following steps 604 and 606.

In step 604, it is determined whether the target robot is located in the deceleration area based on the positioning information.

The positioning information of the target robot is compared with the deceleration area to determine whether the target robot is located in the deceleration area.

In step 606, when the target robot is located in the deceleration area, the speed of the target robot is reduced to the preset speed in the deceleration area, and the communication connection request is continuously sent to the door control system.

Exemplarily, if the determination result obtained in step 604 is that the target robot is located in the deceleration area, the speed of the target robot is reduced to the preset speed, and then it is detected whether a connection channel has been established between the target robot and the door control system. When a connection channel has been established between the target robot and the door control system, the speed is only reduced to the preset speed in the deceleration area.

In this embodiment, the target robot determines whether it is located in the deceleration area based on the real-time positioning information of the target robot, and starts to establish the connection channel with the door control system in the deceleration area, which saves time compared to the case where the target robot starts to try to establish a connection channel with the door control system when it approaches the present door, thereby improving the efficiency of the target robot in passing through the present door.

In an embodiment, obtaining the communication connection result between the target robot and the door control system when the target robot travels to the buffer area, and based on the communication connection result, sending the open instruction to the door control system so as to cause the door control system to open the present door in response to receiving the open instruction includes: when the target robot travels to the buffer area, detecting whether a connection channel is established between the target robot and the door control system; when a connection channel is established between the target robot and the door control system, sending the open instruction to the door control system, so as to cause the door control system to open the present door in response to receiving the open instruction. When a connection channel has not been established between the target robot and the door control system, the target robot stops moving, continuously sends the connection request to the door control system until a connection channel is established between the target robot and the door control system, and sends an open instruction to the door control system.

In this embodiment, the buffer area and the deceleration area of the target robot near the present door are determined, and the target robot is decelerated to the preset speed in the deceleration area. The open instruction is sent to the door control system in the buffer area, so that the target robot can pass through the present door at the preset speed, thereby increasing the success rate of the target robot in passing through the present door.

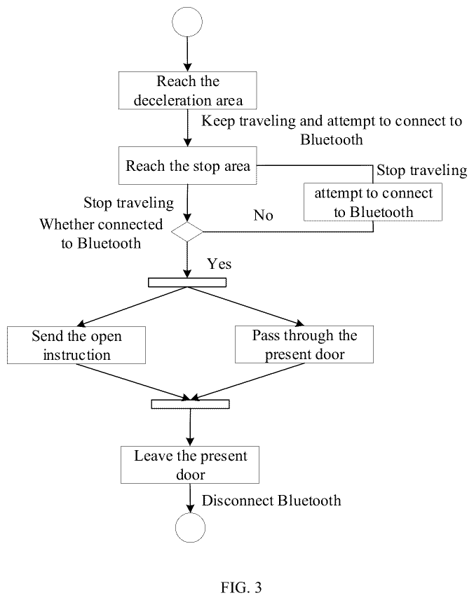

In an embodiment, as shown in FIG. 3, a method for a target robot to pass through a present door is provided, including the following steps 701 to 705.

In step S701, the target robot parses target map information to obtain installation position information, a direction, a distance of a stop area, and a distance of the deceleration area of the present door.

In step S702, when the target robot is located in the deceleration area, it decelerates from the present traveling speed to a specified speed, and attempts to connect to the door control system through Bluetooth. The deceleration is to prevent items from falling off the robot when the target robot reaches the stop area, and at the same time, and connecting in advance is to reduce the time it takes to connect to Bluetooth in the stop area.

In step S703, when the target robot is located in the stop area, it is first detected whether the target robot has established a Bluetooth connection with the door control system. If the connection is established, the open instruction will be sent through Bluetooth. After feedback is obtained, the target robot continues to pass through the present door. If the connection is not established, the target robot stops in the stop area and continues to attempt to connect.

In step S704, the target robot continuously sends the open instruction and continuously moves toward the present door, and passes through the present door, keeping the present door in the open state.

In step S705, after leaving the present door, the target robot sends a close instruction and disconnects Bluetooth.

In this embodiment, by determining the buffer area and deceleration area of the target robot near the present door, slowing down the target robot to the preset speed in the deceleration area, and sending the open instruction to the door control system in the buffer area, the target robot can pass through the present door at the preset speed, thereby enabling the target robot to pass through the present door smoothly.

In an embodiment, the transition area is provided with multiple levels of doors and multiple door control areas, each door control area corresponds to one door in the multiple levels of doors. Controlling the present door to be opened and passing through the present door includes the following steps 802 to 806.

In step 802, when the target robot travels to the door control area corresponding to the present door, the states of other doors are obtained. The present door is the door that the target robot presently needs to pass through, and the other doors are the doors other than the present door in the multiple levels of doors.

The multiple levels of doors usually include multiple doors, for example, it can include two doors, three doors, etc. In this embodiment, the number of doors included in the multiple levels of doors is not limited. The present door mentioned above is usually the door to be passed through. The above-mentioned present door belongs to the above-mentioned multiple levels of doors.

In practice, each door of the above-mentioned multiple levels of doors may have a door control area. For each door, the door control area of the door is usually an area extending from the location of the door to the inner and outer sides of the door by a preset distance. In practical application scenarios, when the target robot pass through a certain door, it usually first arrives at one side of the door control area of the door, and then travels to the other side of the door control area, thus moving away from the door.

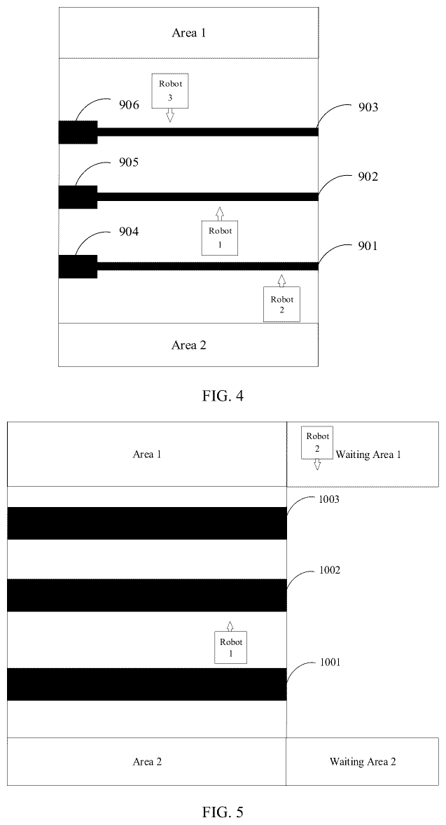

Exemplarily, as shown in FIG. 4, the system architecture diagram includes robots 1 to 3, door control devices 904 to 906, and multiple levels of doors 901 to 903 arranged in series. The door control devices are configured to control the respective doors of the multiple levels of doors to be opened or closed. The three doors arranged in series separates area 1 from area 2. The door control device 904 can be used to control the door 901 to be opened or closed, the door control device 905 can be used to control the door 902 to be opened or closed, and the door control device 906 can be used to control the door 903 to be opened or closed. It should be understood that the numbers of robots, door control devices, and doors in FIG. 4 are only schematic. According to the implementation requirements, there can be any number of robots, door control devices, and doors. In addition, each door can correspond to a door control device. One door can be controlled by one door control device, or multiple doors can be controlled by one door control device.

In practice, during the movement of the target robot, the distance between the target robot and the present door can be detected in real time to determine whether the target robot moves to the door control area of the present door.

In the case where it is determined that the target robot is located in the above-mentioned door control area of the present door, the above-mentioned target robot can obtain the state of each of the other doors in the multiple levels of doors. In practice, the state of the door usually includes an open state and a closed state.

As an example, the target robot can send status inquiry information to the door control device corresponding to each door to obtain the state of each door. Alternatively, the target robot can send status inquiry information to the door control device that serves all the doors to obtain the state of each of the doors.

As another example, the target robot can send information to other robots at other doors in the multiple levels of doors to obtain the state of other doors from other robots at other doors. The above-mentioned other robots are robots other than the target robot.

In step 804, when the state of at least one of the other doors in the multiple levels of doors is closed, the present door is controlled to be opened.

In the above-mentioned multiple levels of doors, when there are other doors in the closed state, the target robot can control the present door to be opened so that the target robot passes through the present door. For example, the open instruction can be sent to the door control device of the present door so that the door control device automatically allows the target robot to pass through. The open instruction can be an access instruction, which is configured to control the door control device corresponding to the present door to open the present door, and close the present door after opening for a preset time. In this way, it can be ensured that there is always a door in the closed state, thereby ensuring that the two areas separated by the multiple levels of doors are not connected.

In practice, when the state of the present door is closed and the state of each of the other doors in the multiple levels of doors is open, the target robot can temporarily not pass through the present door. In this way, it can be ensured that the two areas separated by the multiple levels of doors are not connected.

In step 806, when it is confirmed that the present door is opened, the target robot passes through the present door.

The target robot can determine whether the present door is opened by detecting the distance between the target robot and the present door. The target robot can move through the present door when the present door is opened.

According to the method provided in this embodiment, in the case where the target robot is in the door control area of the present door to be passed through by the target robot, the target robot can passes through the present door after analyzing the opening and closing state of the present door and the opening and closing state of other doors, achieving the passage with the known state of the multiple levels of doors, thereby helping to ensure that two areas separated by the multiple levels of doors are not connected.

In some optional implementations of this embodiment, the above-mentioned robot traversal method can also include the following steps: when the state of each of the other doors in the multiple levels of doors is open, sending a close instruction to the door control device corresponding to a target door among all of the other doors, and controlling the present door to be opened when it is detected that the target door is closed.

The target door can be any door of the multiple levels of doors. The close instruction is configured to trigger the door control device corresponding to the target door to close the target door.

When all other doors are opened, the target robot can send a close instruction to the door control device corresponding to the target door to close the target door. After detecting that the target door is closed, the target robot can request the door control device corresponding to the present door to open the present door so that the target robot passes through the present door. As an example, the target robot can detect whether the target door is closed, by sending a message to the door control device corresponding to the target door to inquire whether it is closed. In this embodiment, timely and accurate passing through the present door can be achieved.

In a possible embodiment of the present disclosure, before step 802, it can also include broadcasting area occupancy information when the target robot travels into the transition area, the area occupancy information being configured to indicate that the transition area is occupied.

The above area occupancy information is used to notify that the transition area is occupied.

When it is determined that the target robot has entered the transition area, the target robot can send the above-mentioned area occupancy information to other robots in the form of broadcasting. In this way, other robots can accurately be informed that the transition area is occupied and wait, which helps to control each robot that needs to pass through the multiple levels of doors to pass through the multiple levels of doors in sequence.

In a possible embodiment of the present disclosure, after step 806, it can also include broadcasting area release information when the target robot moves out of the transition area, the area release information being configured to indicate that the transition area is released.

The above region release information is used to notify that the transition area is released.

When the target robot travels out of the transition area, it can broadcast the area release information to other robots, so that the other robots can be accurately informed that the transition area is released, and they can end waiting and move into the above transition area, which helps to realize that the respective robots pass through the multiple levels of doors in sequence. In practice, the target robot sends the area occupancy information and area release information to other robots in the form of broadcasting, which helps to realize the rapid transmission of information, thereby enabling the respective robots to pass through the multiple levels of doors efficiently and orderly.

FIG. 5 is a schematic diagram of the effect that multiple robots need to pass through the transition area provided by an embodiment of the present disclosure. In FIG. 5, the multiple levels of doors include three doors: door 1001, door 1002, and door 1003, and there is a spacing distance between the doors. The spacing distance between adjacent doors is not limited in the present disclosure. The above-mentioned multiple levels of doors separate area 1 from area 2. A waiting area 1 can be correspondingly provided at area 1, and a waiting area 2 can be correspondingly provided at area 2. As shown in FIG. 5, there are two target robots that need to pass through the transition area, namely robot 1 and robot 2. When robot 1 travels into the transition area, area occupancy information can be broadcast. In this way, robot 2 can wait in the waiting area 1 outside the transition area. In addition, when robot 1 moves out of the transition area, area release information can be broadcast. In this way, robot 2 can end waiting, leave the waiting area 1, and move into the transition area.

It should be pointed out that in some application scenarios, only one robot can appear in the transition area. In this application scenario, the robot entering the transition area notifies other robots that the transition area is occupied by broadcasting area occupancy information. At this time, the other robots need to wait and cannot enter the transition area.

In other application scenarios, multiple robots may appear in the transition area at the same time. In this application scenario, the transition area is divided into multiple transition sub-areas by the multiple levels of doors, and the area occupancy information can notify the specific occupied transition sub-areas in the transition area, i.e., at most one robot can appear in each transition sub-area in the transition area. In this application scenario, a robot entering a transition sub-area can notify other robots that the transition sub-area is occupied by broadcasting area occupancy information. At this time, other robots that need to enter the transition sub-area need to wait and cannot enter the transition sub-area. It can be understood that in this application scenario, in order to ensure that the two areas separated by the multiple levels of doors are not connected, in the transition area, it is necessary to always ensure that the state of at least one door in the multiple levels of doors is closed.

In practice, in a scenario where multiple robots can appear in the transition area at the same time, before entering the transition area, the target robot usually determines whether there are other robots in the transition area that are traveling in the opposite direction of the target robot. If it exists, the target robot may temporarily not enter the transition area regardless of whether the transition sub-area that presently needs to be entered is occupied. If it does not exist, the target robot can enter the transition sub-area if the transition sub-area that presently needs to be entered is not occupied. In this way, it can be ensured that the respective target robots can pass through the multiple levels of doors efficiently and orderly.

In some implementations, broadcasting the area occupancy information as described above may include broadcasting the area occupancy information to at least one of a co-directional device or an opposite-directional device. The co-directional device is typically another robot traveling in the same direction as the target robot. The opposite-directional device is typically another robot traveling in the opposite direction as the target robot.

Here, by sending area occupancy information to other robots in different traveling directions, it is possible to notify other robots in the corresponding traveling directions to wait to enter the multiple levels of doors, thereby controlling the number of target robots in the transition area.

In practical application, the specific robots to which the area occupancy information is broadcasted depends on the size of the transition area. For example, if the transition area is small, the area occupancy information can be broadcasted to both the co-directional device and the opposite-directional device at the same time. In this case, only one target robot can pass through at a time, and only after this target robot passes through the transition area can other robots enter.

In this embodiment, the respective robots that need to pass through the multiple levels of doors can be controlled to pass through the multiple levels of doors efficiently and orderly, thereby helping to improve the efficiency of controlling the robots.

In an optional implementation of some embodiments, when the state of at least one other door in the multiple levels of doors is closed, controlling the present door to be opened includes controlling the present door to be opened when the state of an adjacent door of the present door is closed.

The adjacent door includes at least one of the following: a forward door and a back door. The forward door is adjacent to the present door in the traveling direction of the target robot, and the back door is adjacent to the present door in the direction opposite to the traveling direction of the target robot.

FIG. 6 is a schematic diagram of the positional relationship between the present door, the forward door, and the back door provided by an embodiment of the present disclosure. As shown in FIG. 6, the multiple levels of doors include three doors: door 1101, door 1102, and door 1103. There is a spacing distance between the doors. The spacing distance between adjacent doors is not limited in the present disclosure. The above-mentioned multiple levels of doors separate area 1 from area 2. In practice, area 1 can be an isolation area, and area 2 can be an external environment. In FIG. 6, the traveling direction of the target robot 1 is from the door 1101 to the door 1102. In this case, for the target robot 1, the door 1102 is the present door, the door 1103 is the forward door, and the door 1101 is the back door. In addition, with reference to FIG. 6, the adjacent door of the door 1101 is the door 1102, the adjacent doors of the door 1102 are the door 1101 and the door 1103, and the adjacent door ofthe door 1103 can be the door 1102.

Here, the target robot passes through the present door when the state of the adjacent door is closed, which can further ensure that the two areas separated by the multiple door control areas are not connected.

In an optional implementation of some embodiments, controlling the present door corresponding to the target robot to be opened includes: sending an open instruction to the door control device of the present door, the open instruction being configured to trigger the door control device to open the present door.

After the target robot passes through the present door, the method further includes: sending a close instruction to the door control device, or, if it is determined that there are other robots waiting to pass through the present door, sending the close instruction to the door control device after the other robot passes through the present door.

The open instruction is configured to trigger the door control device of the present door to open the present door. The close instruction is configured to trigger the door control device of the present door to close the present door.

In practice, the door control device corresponding to the present door is typically a device used to control the present door to be opened or closed. In practical application, one door control device can control one door, or one door control device can control multiple doors.

Here, when the state of the present door is closed and there are other doors in the closed state in the multiple levels of doors, the target robot can send the open instruction to the door control device of the present door to open the present door.

After the target robot passes through the present door, the target robot can send a close instruction to the door control device of the present door to close the present door. In practical application, before the target robot sends the close instruction to the door control device of the present door, it can also determine whether there are other robots that need to pass through the present door. As an example, the target robot can interact with other robots through the network to determine whether there are other robots waiting to pass through the present door. In the case that there are other robots waiting to pass through the present door, the target robot can temporarily not send the close instruction to the door control device of the present door. In the case that there is no other robot waiting to pass through the present door, the target robot can send the close instruction to the door control device of the above-mentioned present door. According to this implementation method, the efficiency of controlling the target robot can be further improved by accurately and effectively controlling each door in the multiple levels of doors.

In an optional implementation of some embodiments, sending the open instruction to the door control device of the present door includes: when there are multiple robots in the door control area of the present door, determining a first robot configured to send the open instruction and a second robot configured to send the close instruction from the multiple robots, the multiple robots including the target robot and the other robots; and sending the open instruction to the door control device by the first robot.

The multiple robots can include other robots that are to pass through the present door and located in the door control area of the present door, and the target robot.

The first robot is a robot configured to send an open instruction. The second robot is a robot configured to send a close instruction.

When there are multiple robots in the door control area of the present door, the target robot can select the first robot and the second robot from the multiple robots. For example, the first robot and second robot can be determined by random selection. It is also possible to select the robot closest to the present door as the first robot, and select the robot farthest from the present door as the second robot.

It should be noted that before the second robot sends the close instruction, it can determine whether there are other robots that have not passed through the present door. For example, the second robot can interact with other robots through the network to determine whether there are other robots that have not passed through the present door. When there are other robots that have not passed through the present door, the second robot can temporarily not send the close instruction to the door control device of the present door. When there are no other robots that have not passed through the present door, the second robot can send the close instruction to the door control device of the present door.

It should be pointed out that when there are multiple robots in the door control area of the present door, selecting one robot to send the open instruction and selecting one robot to send the close instruction can reduce the number of instructions and reduce the frequency of opening and closing the present door, compared to the case that each robot needs to send an open instruction and a close instruction. It helps to achieve more efficient and orderly control of multiple robots that need to pass through the multiple levels of doors, thereby further improving the efficiency of controlling the robots.

In some implementations, the above-mentioned determining the first robot configured to send the open instruction and the second robot configured to send the close instruction from the multiple robots includes:
determining the passing order of each of the robots based on travel-related information of each of the robots, and determining the first robot and the second robot from the multiple robots based on the passing order of each of the robots.

The travel-related information includes at least one of the following: a traveling direction, priority information corresponding to the traveling direction, a traveling speed, and a distance to the present door. In practice, the target robot can set priority information for each traveling direction in advance.

For example, with reference to FIG. 4, the priority of the traveling direction from area 1 to area 2 can be set to a high priority, and the priority of the traveling direction from area 2 to area 1 can be set to a low priority.

The target robot can sort all the robots to obtain the passing order of each robot based on the travel-related information of each robot. For example, the robots corresponding to high-priority directions can be sorted more forward, and then the robots with fast traveling speed can be sorted more forward.

It should be noted that the order of the robots can be different or the same. For example, multiple robots can pass through the present door at the same time. In practice, for robots in the same traveling direction, the robots that can pass through the present door faster are usually sorted more forward, which can prevent collisions and blockages, and help each robot pass through the present door efficiently and orderly, thereby further improving the efficiency of controlling the robots.

After obtaining the passing order of each robot, the target robot can select the first robot and the second robot based on the order of each robot. In practice, the robot with the highest order is usually selected as the first robot, and the robot with the lowest order is selected as the second robot. When the order of each robot is the same, any robot can be selected as the first robot, and any robot can be selected as the second robot.

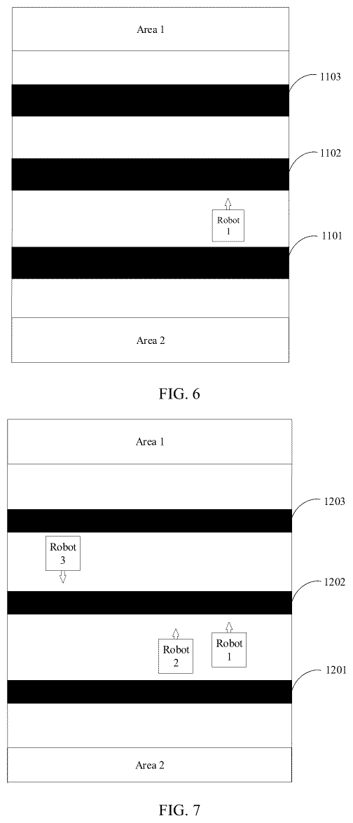

FIG. 7 is a schematic diagram of the effect of the relative position relationship between multiple robots provided in an embodiment of the present disclosure. As shown in FIG. 7, the multiple levels of doors include three doors: door 1201, door 1202, and door 1203, and there is a spacing distance between the doors. The spacing distance between adjacent doors is not limited in the present disclosure. The above-mentioned multiple levels of doors separate area 1 from area 2. In practice, the area 1 can be an isolation area, and the area 2 can be an external environment. With reference to FIG. 7, when the present door is the door 1202, the target devices in the door control area of the present door are robot 1, robot 2, and robot 3. Combined with the travel-related information of each robot, it can be determined that the passing order of each robot can be robot 3-robot 1-robot 2. In this case, robot 3 can serve as the first robot, and robot 2 can serve as the second robot.

In this embodiment, the travel-related information of each robot is used to sort the robots, and then the first robot and the second robot are selected based on a sorting result, which is more practical. In practice, for robots traveling in the same direction, the robot that can pass through the present door faster usually is sorted more forward. This helps the robots pass through the present door efficiently and orderly, thereby further improving the efficiency of controlling the robots.

In optional implementations of some embodiments, before the target robot moves to the door control area corresponding to the present door, the robot traversal method further includes the following steps.

In step 1302, it is detected whether the transition sub-area corresponding to the present door is occupied. The transition sub-area is a part of the transition area that must be passed to get to the present door.

The transition sub-area corresponding to the present door is a necessary area in the transition area for going to the present door. With reference to FIG. 6, for the target robot 1, its traveling direction is from area 2 to area 1, and the present door is the door 1102. In this case, the transition sub-area corresponding to the door 1102 is the area between the door 1101 and the door 1102. For the convenience of description, the area between the door 1101 and the door 1102 is referred to as area A. In practice, for each door, the door control area on the side of the transition sub-area corresponding to the door belongs to the transition sub-area corresponding to the door. For further example, the door control area corresponding to the door 1102 is the area obtained by extending a preset distance from the position of the door 1102 to the direction of the door 1101 and door 1103, respectively. For the target robot 1, the transition sub-area corresponding to the door 1102 is the above-mentioned area A. In this case, the door control area on the side of area A corresponding to the door 1102 belongs to area A.

Before the target robot enters the transition sub-area of the present door, it can first detect whether the transition sub-area of the present door is occupied.

In practice, the target robot can detect whether the transition sub-area corresponding to the present door is occupied by receiving area occupancy information sent by other robots in the transition sub-area. In practice, area occupancy information sent by other robots in the transition sub-area corresponding to a certain door can indicate that the transition sub-area corresponding to the door is occupied.

In step 1304, when the transition sub-area corresponding to the present door is occupied, the target robot does not enter the door control area corresponding to the present door temporarily.

When the transition sub-area corresponding to the present door is occupied, the target robot will not enter the gating area of the present door temporarily.

In step 1306, when the transition sub-area corresponding to the present door is not occupied, the target robot enters the door control area corresponding to the present door.

When the transition sub-area corresponding to the present door is not occupied, the target robot enters the gating area of the present door.

In practical application, before the target robot moves into the transition area, it is usually determined whether there are other robots in the transition area that are traveling in the opposite direction of the target robot. When there are other robots in the transition area that are traveling in the opposite direction of the target robot, the target robot will not enter the door control area of the present door regardless of whether the transition sub-area corresponding to the present door is occupied. When there is no other robot in the transition area that are traveling in the opposite direction of the target robot, the target robot will enter the door control area of the present door when the transition sub-area corresponding to the present door is not occupied.

In this embodiment, the target robot can determine whether to enter the door control area corresponding to the present door based on the occupancy of the transition sub-area of the present door to be passed through. This can ensure that between every two doors or between a door and a partitioned area, only one robot can pass through at a time, which helps to further ensure that the two areas separated by the multiple levels of doors are not connected. When area 1 is a special isolation area, such as an infectious disease isolation area, a potential risk of virus transmission caused by multiple robots in the same space can be avoided.

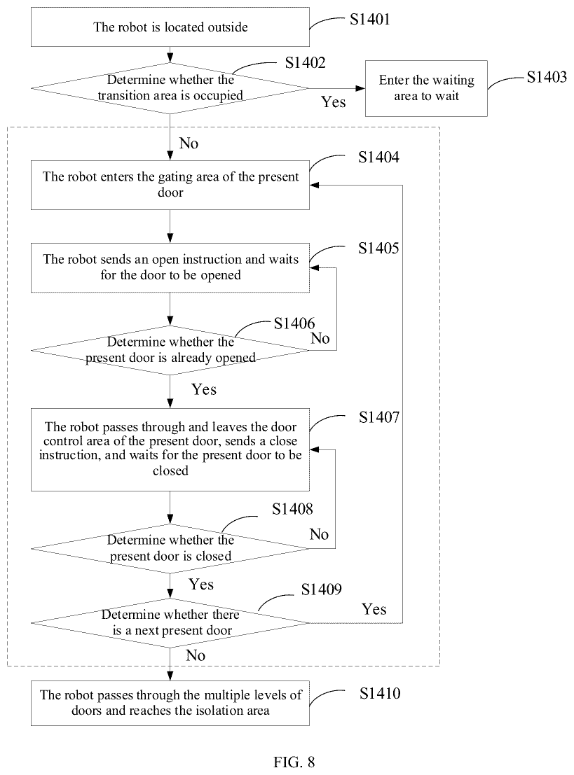

Referring to FIG. 8, which is a flow chart of an implementation of another robot traversal method provided by an embodiment of the present disclosure. As shown in FIG. 8, the robot traversal method in this embodiment is performed by a robot, and an application scenario is that the robot enters an isolation area from outside. In this application scenario, the isolation area can be a first area, and the outside can be a second area. The robot traversal method in this embodiment can include the following step S1401 to step S1410.

In step S1401, the robot is located in the outside.

The robot is the above-mentioned target robot.

In step S1402, the robot determines whether the transition area is occupied. If it is occupied, step S1403 is executed, otherwise step S1404 is executed.

In step S1403, the robot enters the waiting area to wait.

In order to prevent multiple robots from entering the multiple levels of doors at the same time, the two areas separated by the multi-level door each can be provided with a waiting area, so as to control the number of robots in the transition area at the same time. With reference to FIG. 5, a waiting area 1 can be set in area 1, and a waiting area 2 can be set in area 2. In FIG. 5, area 1 can be the first area, i.e., the isolation area, and area 2 can be the second area, i.e., the outside.

In step S1404, the robot enters the door control area of the present door.

The multiple levels of doors can have multiple doors, each of which can be the present door. Each present door can have a corresponding door control area. When the robot enters the door control area of a present door, it can interact with the door control device of the present door to open or close the door.

In step S1405, the robot sends an open instruction and waits for the door to be opened.

In step S1406, the robot determines whether the present door is already opened.

If it is already opened, step S1407 is executed, otherwise step 1405 is executed.

In step S1407, the robot passes through and leaves the door control area of the present door, sends a close instruction, and waits for the present door to be closed.

When the robot travels through the door control area of the present door, it can send a close instruction to the door control device of the present door.

In step 1408, the robot determines whether the present door is closed. If it is closed, step S1409 is executed, otherwise step S1407 is executed.

In step 1409, the robot determines whether there is a next present door. If it exists, step S1404 is executed and the above step S1404 to step S1409 are repeated. If it does not exist, step S1410 is executed.

During the process of executing the above step S1404 to step S1409, the robot can notify other robots that the transition area is occupied by broadcasting to other robots.

In step S1410, the robot passes through the multiple levels of doors.

At this time, the robot completes the traversal from the outside to the isolation area through the multiple levels of doors. At this time, the robot can notify that the transition area has been released by broadcasting.

In an embodiment, the transition area is provided with multiple levels of doors. Controlling the present door to be opened and passing through the present door includes the following steps 1502 to 1506.

In step 1502, a target map is obtained. The target map includes multiple levels of doors arranged in the transition area connecting the first area and the second area.

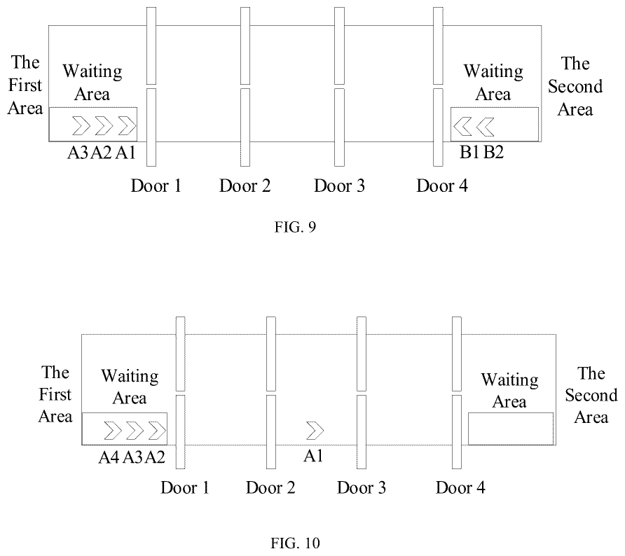

The target map refers to the map used during the running of the target robot. The target map can be a global map or a local map. The multiple levels of doors refer to a set of at least two doors. The door refers to a device that separates the transition area. The door includes but is not limited to communication functions, and opening and closing functions. In a possible embodiment, the door can be a gate in a gate machine. The first area and the second area refer to two areas separated by the multiple levels of doors. For example, as shown in FIG. 9, the transition area connects the first area and the second area, and the multiple levels of doors consisting of four doors are arranged in the transition area, and the isolation of the first area and the second area is achieved by the multi-level gate.

Exemplarily, the target robot obtains the target map used during running. The target map includes the transition area connecting the first area and the second area, and the multiple levels of doors arranged in the transition area.

In an embodiment, the target robot obtains a target map used during running. The target map includes a transition area and multiple levels of doors that the target robot is to pass through. The target robot obtains attribute information corresponding to the transition area, and based on the attribute information, determines that any two adjacent doors in the multiple levels of doors cannot be opened at the same time.

In an embodiment, the target robot obtains a target map used during running. The target map includes a transition area and multiple levels of doors that the target robot is to pass through. The target robot obtains attribute information corresponding to the transition area, and based on the attribute information, determines that the multi-level gate cannot all be opened at the same time.

In step S1504, a first width of the transition area and a second width of the target robot are obtained, and based on the first width and the second width, a number of robots in parallel that are allowed to travel in parallel in the transition area is determined.

The first width refers to the width of the transition area. The second width refers to the width of the target robot. For example, if the target robot is a round sweeping robot, a diameter of the sweeping robot is the second width. In a possible embodiment, the other robots and the target robot have the same width. The number of robots in parallel refers to the maximum number of robots that can travel side by side in the transition area. The number of robots in parallel can be one or more.

Exemplarily, the target robot obtains a first width of the transition area from the target map, obtains a second width of the target robot from a performance parameter list of the target robot, divides the first width by the second width to obtain the number of robots in parallel allowed to travel in parallel in the transition area.

In an embodiment, the target robot obtains a first width of a target passageway from the target map, obtains a second width of the target robot from the drawing of the target robot, divides the first width by the second width to obtain the number of robots in parallel allowed to travel in parallel in the transition area.

In step S1506, based on the number of robots in parallel and the position information of each of the other robots in the transition area, the present door corresponding to the target robot is controlled to be opened, and the present door is passed through.

The position information refers to data representing the position of the robot in the target map. The position information can be represented by coordinates or longitude and latitude.

Exemplarily, the target robot receives the position information of each of the other robots, determines the position of each of the other robots in the target map based on the position information of each of the other robots, determines whether a condition for opening the present door corresponding to the target robot is satisfied based on the number of robots in parallel and the position of each of the other robots in the target map, and controls the present door to be opened if the condition for opening the present door is satisfied, and the target robot passes through the present door.

In this embodiment, the target robot determines the number of robots in parallel allowed to travel in the transition area based on the first width of the transition area and the second width of the target robot. The target robot controls the passage of the target robot based on the number of robots in parallel, avoiding congestion in the transition area that causes the robot to be unable to pass through the transition area. Then, based on the position information of each of the other robots, the position of each of the other robots in the target map is determined. Based on the number of robots in parallel allowed to travel in parallel in the transition area and the position of each of the other robots in the target map, the present door corresponding to the target robot among the multiple levels of doors is controlled to be opened, which can not only satisfy the opening requirements of the multiple levels of doors, but also can timely control the present door to be opened based on the number of robots in parallel and the position of other robots, ensuring that the transition area is unobstructed and the robots can pass through the transition area in sequence, thereby improving the efficiency of the robot passing through the transition area.

In an embodiment, the number of robots in parallel is one, and the robot traversal method further includes the following steps 1602 to 1606.

In step 1602, when the target robot is located in a target waiting area, based on the position information of each the other robots, a determination result of whether there are other robots in an opposite waiting area is obtained. The target waiting area and the opposite waiting area are respectively located at both ends of the transition area.

The target waiting area refers to the waiting area where the target robot is located, and the waiting area is located at one end of the transition area. The target waiting area can be a specific area demarcated at one end of the transition area, or it can be an area at a preset distance from the transition area. The opposite waiting area refers to the waiting area located at the other end of the transition area. The target waiting area and the opposite waiting area are located at the two ends of the transition area, respectively. For example, as shown in FIG. 9, taking robot A1 as the target robot, the waiting area where robot A1, robot A2, and robot A3 are located is the target waiting area, and the waiting area where robot B1 and robot B2 are located is the opposite waiting area.

Exemplarily, when the target robot is located in the target waiting area, the target robot determines the position of each of the other robots in the target map based on the position information of each of the other robots, and obtains a determination result of whether there are other robots in the opposite waiting area based on the position of each of the other robots in the target map.

In step 1604, a passing order of the target robot in the target waiting area is determined based on the position information of each of the other robots.

The passing order refers to the order in which the target robots are arranged in the target waiting area. The passing order will change with the movement of other robots. For example, when the target robot A3 reaches the target waiting area, there are two other robots, robot A1 and robot A2, in the target waiting area, and the number of robots in parallel in the transition area is one. In this case, the passing order of the target robot A3 is the third. When robot A1 leaves the target waiting area, the passing order of the target robot A3 is the second.

Exemplarily, when the number of robots in parallel is one and the target robot is located in the target waiting area, the target robot counts the number of other robots located in the target waiting area based on the position information of each of the other robots to obtain a counted number of other robots in the target waiting area. The counted number is added by one to obtain the passing order of the target robot in the target waiting area.

In step 1606, when it is determined that the target robot does not need to wait based on the determination result and the passing order, based on the number of robots in parallel and the position information of each of the other robots in the transition area, the present door corresponding to the target robot is controlled to be opened, and the present door is passed through.

Exemplarily, based on the determination result and the passing order, if it is determined that the target robot does not need to wait, the present door corresponding to the target robot is controlled to be opened based on the number of robots in parallel and the position information of each of the other robots in the transition area, and the target robot passes through the present door. Based on the determination result and the passing order, if it is determined that the target robot needs to wait, step 1602 and step 1604 are repeated.

In this embodiment, when the number of robots in parallel in the transition area is one and the target robot is located in the target waiting area, firstly, based on the position information of each other robot, it is determined whether there are other robots in the opposite waiting area and the passing order of the target robot in the target waiting area. And then, based on the determination result and the passing order, it is determined whether the target robot needs to wait, so as to prevent the target robot from entering the transition area and causing congestion in the transition area when it needs to wait. In the case where the target robot does not need to wait, based on the number of robots in parallel and the position information of each of the other robots in the transition area, the present door corresponding to the target robot is controlled to be opened, and the present door is passed through, achieving the purpose that the transition area is unobstructed and the robots pass through the transition area in sequence, improving the efficiency of the robot passing through the transition area.

In an embodiment, determining that the target robot does not need to wait based on the determination result and the passing order includes the following steps 1702 and 1704.

In step 1702, when the determination result is that there are no other robots in the opposite waiting area and the passing order is first, it is determined that the target robot does not need to wait.

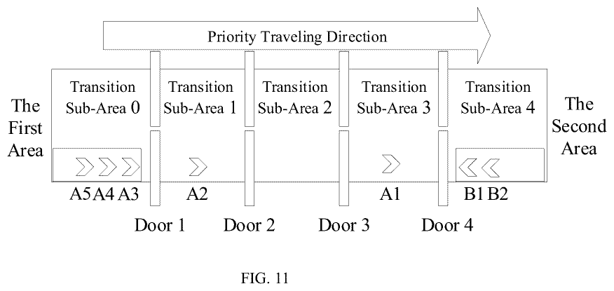

Exemplarily, when the number of robots in parallel in the transition area is one and the target robot is in the target waiting area, if the target robot determines that there are no other robots in the opposite waiting area and the passing order of the target robot is the first, it is determined that the target robot does not need to wait. For example, as shown in FIG. 10, assuming that the target robot is A2, the robot A2 determines that there are no other robots in the opposite waiting area and the passing order is the first, then it determines that the target robot A2 does not need to wait.

In step 1704, when the determination result is that there are other robots in the opposite waiting area, a priority traveling direction corresponding to the transition area and a target traveling direction of the target robot are obtained. When the target traveling direction is the same as the priority traveling direction and the passing order is the first, it is determined that the target robot does not need to wait.

The priority traveling direction refers to the traveling direction that gives priority to pass through the transition area. The target traveling direction refers to the traveling direction of the target robot passing through the transition area. For example, as shown in FIG. 11, traveling from the first area to the second area is one traveling direction, and traveling from the second area to the first area is another traveling direction. If the priority traveling direction corresponding to the transition area is from the first area to the second area, then A3 located in the waiting area does not need to wait, even if the passing order of B1 is the first, but B1 needs to wait because the traveling direction of B1 is inconsistent with the priority traveling direction.

Exemplarily, when the number of robots in parallel in the transition area is one and the target robot is located in the target waiting area, if the target robot determines that there are other robots in the opposite waiting area, the priority traveling direction corresponding to the transition area and the target traveling direction of the target robot are obtained. The priority traveling direction and the target traveling direction are compared, and when the target traveling direction is the same as the priority traveling direction and the passing order of the target robot is the first, it is determined that the target robot does not need to wait.

In this embodiment, when the number of robots in parallel in the transition area is one and the target robot is located in the target waiting area, it is first determined whether there are other robots in the opposite waiting area. When there are no other robots in the opposite waiting area, the robots in the target waiting area pass through the transition area in order. The robots in the target waiting area pass through the transition area in sequence, which avoids congestion in the transition area and improves the efficiency of the robots passing through the transition area. When there are other robots in the opposite waiting area, the robots in the target waiting area and the opposite waiting area that travel in the same direction as the priority traveling direction will pass through the transition area first, and the robots that travel in the opposite direction of the priority traveling direction will wait, so as to avoid the robots in the target waiting area and the opposite waiting area moving at the same time and causing congestion in the transition area, thus ensuring that the transition area is unobstructed and improving the efficiency of the robot passing through the transition area.

In an embodiment, the number of robots in parallel is at least two, and the robot traversal method further includes the following steps 1802 to 1810.

In step 1802, when the target robot is located in the target waiting area, based on the position information of each of the other robots, a determination result of whether there are other robots in the opposite waiting area is obtained.

In step 1804, if the determination result is that there are no other robots in the opposite waiting area, the number of robots in parallel is taken as a target number of the robots in a parallel group in the target waiting area.

The parallel group refers to a group of robots traveling in parallel. The target number of the robots refers to the number of the robots included in the parallel group.

Exemplarily, if the determination result is that there are no other robots in the opposite waiting area, the target robot obtains the number of robots in parallel in the transition area, and uses the number of robots in parallel as the target number of the robots in the parallel group in the target waiting area.

In step 1806, if the determination result is that there are other robots in the opposite waiting area, the priority traveling direction corresponding to the transition area and the target traveling direction of the target robot are obtained, and the target number of the robots in the parallel group in the target waiting area is determined based on the priority traveling direction, the target traveling direction and the number of robots in parallel.

Exemplarily, if the determination result is that there are other robots in the opposite waiting area, the target robot obtains the priority traveling direction corresponding to the transition area and the target traveling direction of the target robot, and compares the priority traveling direction with the target traveling direction to obtain a comparison result. Based on the comparison result and the number of the robots in parallel, the target number of the robots in the parallel group in the target waiting area is determined.

In an embodiment, if the determination result is that there are other robots in the opposite waiting area, the target robot obtains the priority traveling direction corresponding to the transition area and the target traveling direction of the target robot, and compares the priority traveling direction with the target traveling direction to obtain a target comparison result. A correspondence between comparison results and target ratios is obtained, including a first ratio corresponding to the comparison result that the target traveling direction is the same as the priority traveling direction and a second ratio corresponding to the comparison result that the target traveling direction is the different from the priority traveling direction. The target ratio is obtained based on the target comparison result and the correspondence, and the target number of the robots in the parallel group in the target waiting area is obtained based on the target ratio and the number of the robots in parallel.

In step 1808, based on the target number of the robots, the passing order of a target parallel group to which the target robot belongs in the target waiting area is determined.

Exemplarily, the target robot determines the counted number of other robots already being in the target waiting area based on the position information of the other robots, and the passing order of the target parallel group to which the target robot belongs in the target waiting area is determined based on the counted number and the target number of the robots.

In step S1810, when it is determined based on the passing order that the target robot does not need to wait, based on the number of robots in parallel and the position information of each of the other robots in the transition area, the present door corresponding to the target robot is controlled to be opened and the present door is passed through.

In this embodiment, when the number of robots in parallel in the transition area is at least two and the target robot is located in the target waiting area, it is first determined whether there are other robots in the opposite waiting area. When there are no other robots in the opposite waiting area, the robots in the target waiting area pass through the transition area sequentially in accordance with the order of the parallel groups. The robots in the target waiting area pass through the transition area in sequence, which improves the efficiency of the robots passing through the transition area. When there are other robots in the opposite waiting area, based on the priority traveling direction, the target traveling direction and the number of robots in parallel, the target number of the robots in the parallel group in the target waiting area is determined. The robots in the target waiting area form parallel groups based on the target number of the robots and pass through the transition area sequentially in accordance with the order of the parallel groups, avoiding congestion in the transition area, thus ensuring that the transition area is unobstructed and improving the efficiency of the robot passing through the transition area.

In an embodiment, the number of robots in parallel is one. Based on the number of robots in parallel and the position information of each of the other robots in the transition area, controlling the present door corresponding to the target robot to be opened and passing through the present door includes the following steps 1902 to 1908.

In step 1902, a target position information of the target robot is obtained.

The target position information refers to the present position information of the target robot.

In step 1904, a present transition sub-area, a present door and a reference door corresponding to the target robot are determined based on the target position information and the installation position information of each door in the multiple levels of doors. The present transition sub-area is the first transition sub-area presently to be passed through by the target robot. The present door is the first door presently to be passed through by the target robot, and the reference door is the second door presently to be passed through by the target robot.

The installation position information refers to the position information of the door. The transition sub-area refers to a partial passageway divided by the multiple levels of doors in the transition area. For example, as shown in FIG. 11, four doors divide the transition area into five transition sub-areas, namely transition sub-area 0, transition sub-area 1, transition sub-area 2, transition sub-area 3, and transition sub-area 4. Assuming that A3 is the target robot, then transition sub-area 1 is the first transition sub-area to be passed through by A3, i.e., transition sub-area 1 is the present transition sub-area for A3, door 1 is the first door to be passed through by A3, i.e., door 1 is the present door for A3, and door 2 is the second door to be passed through by A3, i.e., door 2 is the reference door for A3.

Exemplarily, the target robot obtains the installation position information of each door in the multiple levels of doors from the target map, calculates the distance between each door and the target robot in the traveling direction based on the target position information and the installation position information of each door, takes the door corresponding to the smallest distance as the present door, takes the door corresponding to the second smallest distance as the reference door, and takes the transition sub-area between the present door and the reference door as the present transition sub-area.

In step 1906, based on the position information of each other robot, it is determined that there are no other robots in the present transition sub-area.

Exemplarily, the target robot determines the position of each other robot in the target map based on the position information of each other robot, and determines whether there are other robots in the present transition sub-area based on the position of each other robot in the target map. When there are other robots in the present transition sub-area, the target robot repeatedly performs step 1906 to obtain the updated position information of each of the other robots until it is determined that there are no other robots in the present transition sub-area, and then the target robot performs step 1908. When there are no other robots in the present transition sub-area, the target robot performs step 1908.

In step 1908, the state of the reference door is obtained. If the state is closed, the present door is controlled to be opened and the present door is passed through.

The state refers to the state of the door. The state includes, but is not limited to, opened, opening, closing, and closed. Closed means that the door is in a closed state.

Exemplarily, the target robot obtains the state of the reference door. If the state of the reference door is closed, the target robot sends an open instruction to the present door to control the present door to be opened, and the target robot passes through the present door.

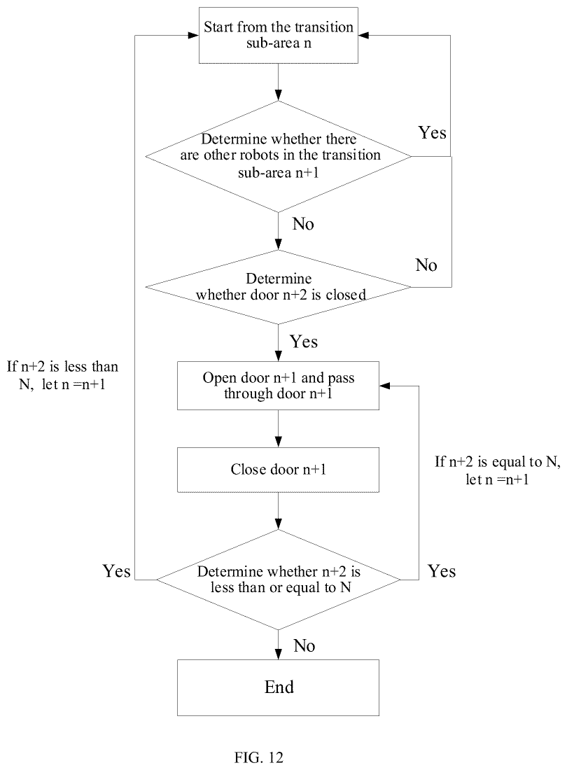

In an embodiment, when the number of robots in parallel is one, the target robot is located in the target waiting area, and the target robot does not need to wait, the flow chart of the target robot passing through the multiple levels of doors is shown in FIG. 12. Assuming that the target robot passes through the transition area shown in 11, where n represents a serial number, the value of n starts from 0, N represents the maximum serial number, N is equal to 4, and the target robot starts from the transition sub-area n. The target robot determines whether there are other robots in the transition sub-area n+1. If there are other robots in the transition sub-area n+1, the target robot continues to start from the transition sub-area n. If there are no other robots in the transition sub-area n+1, it is determined whether the door n+2 is closed. If it is not closed, the target robot continues to start from the transition sub-area n. If it is closed, the door n+1 is opened, the target robot pass through the door n+1. The target robot enters the transition sub-area n+1, closes the door n+1, and then determines whether n+2 is less than or equal to N. If n+2 is less than or equal to N, and n+2 is less than N, then let n=n+1, and the target robot repeats the above steps. If n+2 is less than or equal to N, and n+2 is equal to N, then let n=n+1, the target robot opens the door n+1, and pass through the door n+1. If n+2 is greater than N, the target robot has passed through the multiple levels of doors in the transition area.

In this embodiment, the target robot determines whether there are other robots in the present transition sub-area based on the position information of each other robot. The target robot controls the present door to be opened only when there are no other robots in the present transition sub-area and the reference door is in a closed state, which not only prevents the target robot and other robots in the present transition sub-area from opening the present door and the reference door at the same time, but also prevents the target robot from opening the present door during the opening or closing process of the reference door, avoiding the door in the transition area being locked caused by two adjacent doors being opened at the same time, thereby ensuring that the transition area is unobstructed and improving the efficiency of the robot passing through the transition area.

In an embodiment, the number of robots in parallel is at least two, and the target robot is an active robot. Based on the number of robots in parallel and the position information of each of the other robots in the transition area, controlling the present door corresponding to the target robot to be opened and passing through the present door includes the following steps 2002 to 2008.

In step 2002, the target traveling direction and target position information of the target robot are obtained.

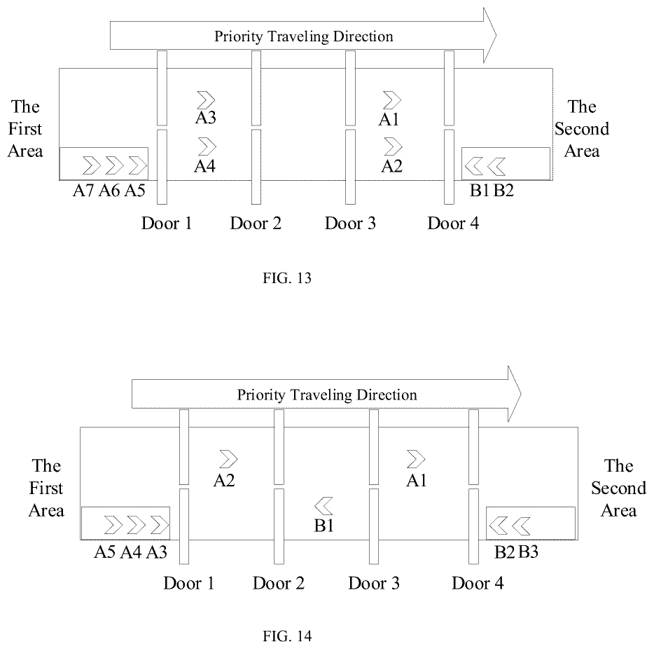

The active robot is a robot that controls the door to be opened or closed. The passive robot is a robot that does not control the door to be opened and closed. It can be understood that among multiple robots that need to pass through the same door, one of the robots is the active robot, and the remaining robots are the passive robots. The active robot controls the door to be opened and closed, and the passive robot passes through the door when the door is open. For example, as shown in FIG. 13, A1 and A2 form a parallel group, and A3 and A4 form a parallel group. If the robot that is first in order in the parallel group is set as the active robot, A1 and A3 are active robots, A2 and A4 are passive robots, and the present door of A1 and A2 is door 4, then A1 controls the door 4 to be opened and closed, and A2 waits when the door 4 is closed and pass through the door 4 when the door 4 is opened. For example, as shown in FIG. 14, A2 and B1 need to pass through the door 2. If the robot whose traveling direction is the same as the priority traveling direction is set as the active robot, then A2 is the active robot and B1 is the passive robot. A2 controls the door 2 to be opened and closed, and B1 passes through the door 2 when the door 2 is opened.

In an embodiment, when there are multiple robots in the door control area of the present door, including a target robot and at least one other robot, the active robot configured to send the open instruction and the close instruction is determined from the multiple robots, and the open instruction is sent to the door control device by the active robot.

In step 2004, based on the target position information and the installation position information of each door in the multiple levels of doors, the present transition sub-area, the present door and the reference door corresponding to the target robot are determined. The present transition sub-area is the first transition sub-area to be passed through by the target robot, the present door is the first door to be passed through by the target robot, and the reference door is the second gate to be passed through by the target robot.

In step 2006, based on the traveling direction and position information of each other robot and the target traveling direction, it is determined that there are no other robots with the same traveling direction as the target traveling direction in the present transition sub-area.

Exemplarily, the target robot determines the position of each other robot in the target map based on the position information of each other robot, and determines whether there are other robots in the present transition sub-area based on the position of each other robot in the target map. When there are other robots in the present transition sub-area, the traveling directions of the other robots in the present transition sub-area are obtained, and the traveling directions are compared with the target traveling direction. If the traveling directions are all different from the target traveling direction, it is determined that there are no other robots with the same traveling direction as the target traveling direction in the present transition sub-area, and step 2008 is executed. When there is at least one other robot with the same traveling direction as the target traveling direction, it is determined that there are other robots with the same traveling direction as the target traveling direction in the present transition sub-area, and the updated position information of each robot are repeatedly obtained and step 2006 are repeatedly executed until it is determined that there are no other robots with the same traveling direction as the target traveling direction in the present transition sub-area, and step 2008 is executed. When there are no other robots in the present transition sub-area, step 2008 is executed.

In step 2008, the state of the reference door is obtained. If the state is closed, the present door is opened and the present door is passed through.

Exemplarily, the target robot obtains the state of the reference door. If the state of the reference door is open, the process of obtaining the state of the reference door is repeated until the state of the reference door is closed, then the present door is controlled to be opened, and the target robot passes through the present gate. If the state of the reference door is closed, the present door is controlled to be opened and the target robot passes through the present door.

In an embodiment, the above method also includes: when there are other robots in the opposite waiting area, determining a candidate robot based on the priority traveling direction corresponding to the transition area and the traveling direction of each other robot. In a possible embodiment, the other robots with the same traveling direction as the priority traveling direction are determined as the candidate robots, and one candidate robot in the parallel group is determined as the active robot. The active robot controls the door to be opened or closed. When there are no other robots in the opposite waiting area, one robot in the parallel group is determined as the active robot based on a preset method.

In an embodiment, the above method further includes: when there are multiple robots waiting to pass in the door control area of the present door, and the multiple robots waiting to pass include the target robot and at least one other robot, determining a first target device configured to send the open instruction and a second target device configured to send the close instruction from the multiple robots waiting to pass. The first target device serves as the active robot, and the open instruction is sent to the door control device by the active robot.

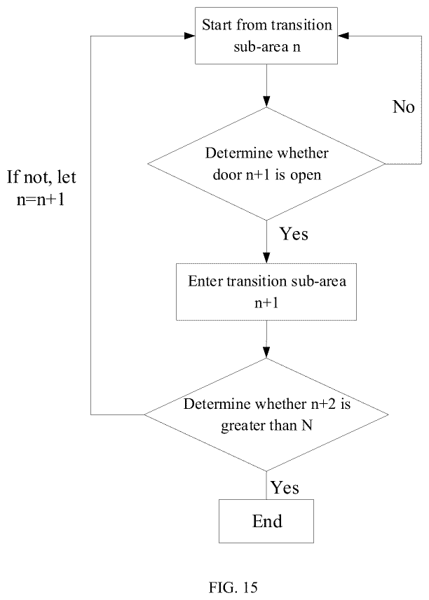

In an embodiment, when the target robot is the passive robot, a flow chart of the target robot passing through multiple levels of doors is shown in FIG. 15. The target robot passes through the transition area shown in FIG. 13, where n represents a serial number, the value of n starts from 0, N represents the maximum serial number, N is equal to 4, and the target robot starts from transition sub-area n. The target robot determines whether the door n+1 is opened. If the door n+1 is not opened, the target robot continues to start from transition sub-area n. If the door n+1 is opened, the target robot pass through the door n+1. The target robot enters the transition sub-area n+1 and determines whether n+2 is greater than N. If n+2 is less than or equal to N, let n=n+1, and the above steps are repeated. If n+2 is greater than N, the target robot has passed through the multiple levels of doors in the transition area.

In this embodiment, the active robot controls the door to be opened or closed, which can prevent the door from being locked caused by multiple robots opening and closing the door at the same time. The door only needs to be opened once for the multiple robots in the parallel group to pass through the door, avoiding repeated opening and closing of the door, thereby improving the efficiency of the robots passing through the door, and further improving the efficiency of the robots passing through the transition area.

In an embodiment, the robot traversal method further includes the following steps 2102 to 2108.

In step 2102, when the target robot passes through the present gate, updated position information and updated traveling direction of each other robot are obtained.

In step 2104, based on the updated position information of each other robot, it is determined that other robots in the target parallel group to which the target robot belongs are located in the present transition sub-area.

In step 2106, based on the updated position information and updated traveling direction of each other robot, it is determined that there are no other robots in the present transition sub-area traveling in the direction opposite to the target traveling direction.

In step 2108, the present door is controlled to be closed.

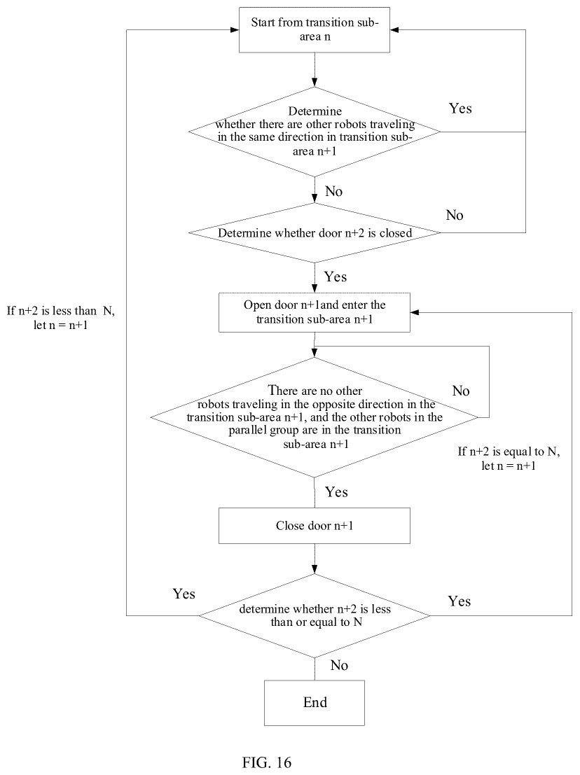

In an embodiment, when the target robot is an active robot, a flow chart of the target robot passing through multiple levels of doors is shown in FIG. 16. Assuming that the target robot passes through the transition area shown in FIG. 14, where n represents a serial number, the value of n starts from 0, N represents the maximum serial number, N is equal to 4, and the target robot starts from the transition sub-area n. The target robot determines whether there are other robots traveling in the same direction in the transition sub-area n+1. If yes, the target robot continues to start from the transition sub-area n. If not, it determines whether the door n+2 is closed. If the door n+2 is not closed, the target robot continues to start from the transition sub-area n. If the door n+2 is closed, the door n+1 is opened, the target robot passes through the door n+1 and enters the transition sub-area n+1, and determines whether there are other robots traveling in the opposite direction in the transition sub-area n+1 and whether the other robots in the parallel group are in the transition sub-area n+1. When there are other robots traveling in the opposite direction in the transition sub-area n+1, or any of the other robots in the parallel group is not in the transition sub-area n+1, the determination of whether there are other robots traveling in the opposite direction in the transition sub-area n+1 and whether the other robots in the parallel group are in the transition sub-area n+1 are repeated. When there are no other robots traveling in the opposite direction in the transition sub-area n+1 and all the other robots in the parallel group are in the transition sub-area n+1, the door n+1 is closed. Then, it is determined whether n+2 is less than or equal to N. If n+2 is less than or equal to N, and n+2 is less than N, let n=n+1, and then the above steps are repeated. If n+2 is less than or equal to N, and n+2 is equal to N, then let n=n+1, the door n+1 is opened, and the target robot passes through the door n+1 and enters the transition sub-area n+1. If n+2 is greater than N, the target robot has passed through the multiple levels of doors in the transition area.

In this embodiment, when the active robot enters the present transition sub-area, it is determined whether other robots in the present transition sub-area that travels in the direction opposite to the target traveling direction has passed through the present door, and whether all other robots in the target parallel group to which the target robot belongs has passed through the present door. The door only needs to be opened once for the multiple robots in the parallel group and the robots located in the present transition sub-area traveling in the direction opposite to the target traveling direction to pass through the door, avoiding repeated opening and closing of the door, and improving the speed of robots passing through the multiple levels of doors. In addition, the present door is closed in time, which shortens the waiting time for the next other robot to pass through the present door, and further improves the efficiency of the robot passing through the multiple levels of doors.

It should be understood that although the steps in the flow charts involved in the above-mentioned embodiments are shown in sequence as indicated by the arrows, these steps are not necessarily executed in the order indicated by the arrows. Unless explicitly stated in this article, there is no strict order restriction on the execution of these steps, and these steps can be executed in other orders. Moreover, at least some of the steps in the flow charts involved in the above embodiments may include multiple steps or multiple stages. These steps or stages are not necessarily executed at the same time, but can be completed at different times. The execution order of these steps or stages is not necessarily sequential, but can be performed in turn or alternately with other steps or at least part of the steps or stages in other steps.

Based on the same inventive concept, the embodiment of the present disclosure also provides a robot traversal device for implementing the robot traversal method involved above. The solution for solving the problem provided by the device is similar to the solution described in the above method, so that the specific limitations in one or more embodiments of the robot traversal device provided below can refer to the limitations of the robot traversal method above, and will not be repeated here.

In an embodiment, a robot traversal device is provided, including a determination module and a passing through module.

The determination module is configured to determine a present door corresponding to the target robot in a transition area when the target robot moves to the transition area.

The passing though module is configured to control the present door to be opened and control the target robot to pass through the present door.

In an embodiment, the passing through module is also configured to: obtain traveling state information of the target robot, which includes traveling speed information and pose information; determine a deceleration area based on a target map of the target robot, the traveling speed information, and the pose information, and determine a buffer area based on the deceleration area; when the target robot travels to the deceleration area, control the target robot to travel at a preset speed and send a communication connection request to a door control system; when the target robot travels to the buffer area, obtain the communication connection result between the target robot and the door control system, and based on the communication connection result, send an open instruction to the door control system, so as to cause the door control system to open the present gate door in response to receiving the open instruction; and control the target robot to pass through the present door.

In an embodiment, the passing through module is also configured to: when the target robot moves to the door control area corresponding to the present door, obtain the state of other doors, the present door being the door that the target robot presently needs to pass through, and the other doors being the doors in the multiple levels of doors other than the present door; when the state of at least one other door in the multiple levels of doors is closed, control the present door to be opened; and when it is confirmed that the present door is opened, control the target robot to pass through the present door.

In an embodiment, the passing through module is also configured to: obtain a target map, the target map including multiple levels of doors, and the multiple levels of doors being arranged in a transition area connecting a first area and a second area; obtain a first width of the transition area and a second width of the target robot, and based on the first width and the second width, determine a number of robots in parallel that are allowed to travel in parallel in the transition area; and based on the number of robots in parallel and the position information of each other robot in the transition area, control the present door corresponding to the target robot to be opened and control the target robot to pass through the present door.

Each module in the above-mentioned robot traversal device can be realized in whole or in part by software, hardware and combinations thereof. Each of the above modules can be embedded in or independent of a processor of a computer device in the form of hardware, or can be stored in a memory of the computer device in the form of software, so as to be called by the processor to perform the operations corresponding to the above modules.

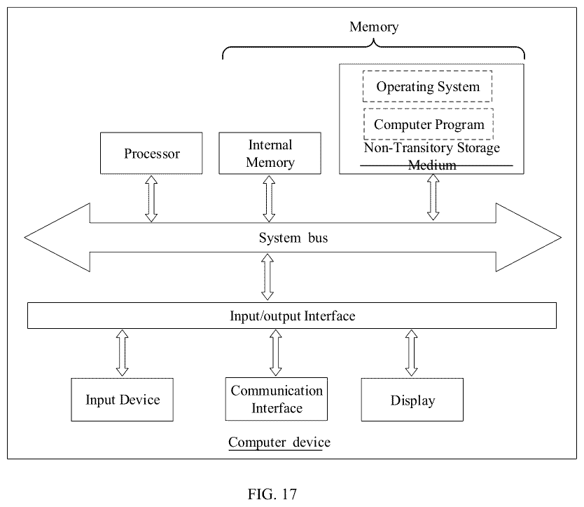

In an embodiment, a computer device is provided. The computer device can be a robot, and its schematic diagram of an internal structure can be as shown in FIG. 17. The computer device includes a processor, a memory, an input/output interface, a communication interface, a display unit and an input device. The processor, memory and input/output interface are connected through a system bus, and the communication interface is connected to the system bus through the input/output interface. The processor of the computer device is configured to provide computing and control capabilities. The memory of the computer device includes non-transitory storage medium and internal memory. The non-transitory storage medium stores an operating system and a computer program. The internal memory provides an environment for the execution of the operating system and the computer program in the non-transitory storage medium. The input/output interface of the computer device is configured to exchange information between the processor and external devices. The communication interface of the computer device is used for wired or wireless communication with external terminals. The wireless mode can be implemented through WIFI, mobile cellular network, NFC (Near Field Communication) or other technologies. The computer program, when executed by the processor, implements the robot traversal method.

Those skilled in the art can understand that the structure shown in FIG. 17 is only a block diagram of a partial structure related to the solution of the present disclosure, and does not constitute a limitation on the computer device to which the solution of the present disclosure is applied. Specific computer device can include more or fewer parts than shown, or combine certain parts, or have a different arrangement of parts.

In an embodiment, a robot is provided, including a memory and a processor. A computer program is stored in the memory. When the processor, when executes the computer program, performs the steps in the above method embodiments.

In an embodiment, a computer-readable storage medium is provided, on which a computer program is stored. When the computer program is executed by a processor, the steps in the above method embodiments are implemented.

In an embodiment, a computer program product is provided, including a computer program that implements the steps in each of the above method embodiments when executed by a processor.

It should be noted that the user information (including but not limited to user device information, user personal information, etc.) and data (including but not limited to data used for analysis, stored data, displayed data, etc.) involved in this disclosure are those authorized by the user or fully authorized by all parties.

A person of ordinary skill in the art can understand that all or part of the processes in the above-mentioned embodiment method can be completed by instructing the relevant hardware through a computer program, and the computer program can be stored in a non-transitory computer-readable storage medium. When the computer program is executed, it can include the processes of the embodiments of the above-mentioned methods. Any reference to the memory, database or other medium used in the embodiments provided in the present disclosure can include at least one of non-volatile and volatile memory. Non-volatile memory can include read-only memory (ROM), magnetic tape, floppy disk, flash memory, optical memory, high-density embedded non-volatile memory, resistive random access memory (ReRAM), magnetic random access memory (MRAM), ferroelectric random access memory (FRAM), phase change memory (PCM), graphene memory, etc. Volatile memory can include random access memory (RAM) or external cache memory, etc. As an illustration and not a limitation, RAM can be in various forms, such as static random access memory (SRAM) or dynamic random access memory (DRAM). The database involved in each embodiment provided in this disclosure may include at least one relational database and a non-relational database. Non-relational databases may include distributed databases based on blockchains, etc., but are not limited to this. The processor involved in each embodiment provided in this disclosure can be a general-purpose processor, a central processing unit, a graphics processor, a digital signal processor, a programmable logic unit, a data processing logic unit based on quantum computing, etc., but are not limited to this.

The technical features of the above embodiments can be randomly combined. To simplify the description, not all possible combinations of the technical features in the above embodiments are described. However, as long as there is no contradiction in the combination of these technical features, all the combinations should be considered to be included within the scope of this specification.

The above-described embodiments only illustrate several embodiments of the present disclosure, and the descriptions of which are relatively specific and detailed, but should not be construed as limiting the scope of the patent disclosure. It should be noted that, for those of ordinary skill in the art, several modifications and improvements can be made without departing from the concept of the present disclosure, and these all fall within the protection scope of the present disclosure. Therefore, the protection scope of the present disclosure should be determined by the appended claims.

1. A robot traversal method, the method being applied to a target robot, and the target robot being any robot among multiple robots that need to pass through a transition area, the method comprising:
determining, when the target robot travels to the transition area, a present door corresponding to the target robot in the transition area; and
controlling the present door to be opened and passing through the present door.

2. The method according to claim 1, wherein controlling the present door to be opened and passing through the present door comprises:
obtaining traveling state information of the target robot, the traveling state information comprising traveling speed information and pose information;
determining a deceleration area based on a target map of the target robot, the traveling speed information and the pose information, and determining a buffer area based on the deceleration area;
traveling at a preset speed and sending a communication connection request to a door control system when the target robot travels to the deceleration area;
obtaining a communication connection result between the target robot and the door control system when the target robot travels to the buffer area, and based on the communication connection result, sending an open instruction to the door control system, so as to cause the door control system to open the present door in response to receiving the open instruction; and
passing through the present door.

3. The method according to claim 2, wherein determining the deceleration area based on the target map of the target robot, the traveling speed information and the pose information comprises:
obtaining a travelable path of the target robot from the target map, and determining a start line of the deceleration area from the travelable path of the target robot;
determining a deceleration distance based on the traveling speed information; and
determining the deceleration area based on the pose information, the deceleration distance, and the start line of the deceleration area.

4. The method according to claim 3, wherein determining the buffer area based on the deceleration area comprises:
extracting an end line of the deceleration area from the deceleration area, the end line of the deceleration area serving as a start line of the buffer area;
obtaining installation position information of the present door from the target map, and determining an end line of the buffer area based on the installation position information of the present door; and
determining the buffer area based on the start line of the buffer area and the end line of the buffer area.

5. The method according to claim 2, wherein obtaining the traveling state information of the target robot comprises:
obtaining positioning information of the target robot; and
wherein traveling at the preset speed and sending the communication connection request to the door control system when the target robot travels to the deceleration area, comprises:
determining whether the target robot is located in the deceleration area based on the positioning information; and
reducing the traveling speed of the target robot to a preset speed in the deceleration area, and continuously sending the communication connection request to the door control system when the target robot is located in the deceleration area.

6. The method according to claim 2, wherein obtaining the communication connection result between the target robot and the door control system when the target robot travels to the buffer area, and based on the communication connection result, sending the open instruction to the door control system, so as to cause the door control system to open the present door in response to receiving the open instruction comprises:
detecting whether a connection channel is established between the target robot and the door control system when the target robot travels to the buffer area; and
sending the open instruction to the door control system when the connection channel is established between the target robot and the door control system, so as to cause the door control system to open the present door in response to receiving the open instruction.

7. (canceled)

8. The method according to claim 1, wherein the transition area is provided with multiple levels of doors and multiple door control areas, and each of the door control areas corresponds to one door of the multiple levels of doors; and
wherein controlling the present door to be opened and passing through the present door comprises:
obtaining states of other doors when the target robot travels to the door control area corresponding to the present door, the present door being the door that the target robot presently needs to pass through, and the other doors being the doors other than the present door in the multiple levels of doors;
controlling the present door to be opened when the state of at least one of the other doors in the multiple levels of doors is closed; and
passing through the present door when it is confirmed that the present door is open.

9. The method according to claim 1, wherein controlling the present door to be opened comprises:
sending an open instruction to a door control device of the present door, the open instruction being configured to trigger the door control device to open the present door; and
wherein after passing through the present door, the method further comprises;
sending a close instruction to the door control device, or if it is determined that there are other robots waiting to pass through the present door, sending the close instruction to the door control device after the other robots pass through the present door.

10. The method according to claim 9, wherein sending the open instruction to the door control device of the present door comprises:
determining, when there are multiple robots in a door control area of the present door, a first robot configured to send the open instruction and a second robot configured to send the close instruction from the multiple robots, the multiple robots comprising the target robot and the other robots; and
sending the open instruction to the door control device by the first robot.

11. The method according to claim 10, wherein determining the first robot configured to send the open instruction and the second robot configured to send the close instruction from the multiple robots, comprises:
determining a passing order of each of the robots based on travel-related information of each of the robots, and determining the first robot and the second robot from the multiple robots based on the passing order of each of the robots; and
wherein the travel-related information comprises at least one of the following: a traveling direction, priority information corresponding to the traveling direction, a traveling speed, and a distance to the present door.

12. The method according to claim 1, wherein the method further comprises:
broadcasting area occupancy information when the target robot travels into the transition area, the area occupancy information being configured to indicate that the transition area is occupied; and
broadcasting area release information when the target robot travels out of the transition area, the area release information being configured to indicate that the transition area is released.

13. The method according to claim 8, wherein before the target robot travels to the door control area corresponding to the present door, the method further comprises:
detecting whether a transition sub-area corresponding to the present door is occupied, the transition sub-area being a part of the transition area that must be passed to get to the present door;
temporarily not entering the door control area corresponding to the present door when the transition sub-area corresponding to the present door is occupied; and
entering the door control area corresponding to the present door when the transition sub-area corresponding to the present door is not occupied.

14. (canceled)

15. The method according to claim 1, wherein controlling the present door to be opened and passing through the present door comprises:
obtaining a target map, the target map comprising multiple levels of doors, the multiple levels of doors being arranged in the transition area connecting a first area and a second area;
obtaining a first width of the transition area and a second width of the target robot, and determining, based on the first width and the second width, a number of robots in parallel that are allowed to travel in parallel in the transition area; and
controlling the present door corresponding to the target robot to be opened and passing through the present door based on the number of robots in parallel and position information of each other robot in the transition area.

16. The method according to claim 15, wherein the number of robots in parallel is one, and the method further comprises:
obtaining, when the target robot is located in a target waiting area, a determination result of whether there are other robots in an opposite waiting area based on the position information of each other robot, the target waiting area and the opposite waiting area being located in two ends of the transition area, respectively;
determining a passing order of the target robot in the target waiting area based on the position information of each other robot; and
controlling, when it is determined that the target robot does not need to wait based on the determination result and the passing order, the present door corresponding to the target robot to be opened and passing through the present door based on the number of robots in parallel and the position information of each other robot in the transition area.

17. The method according to claim 16, wherein determining that the target robot does not need to wait based on the determination result and the passing order comprises:
determining that the target robot does not need to wait when the determination result is that there are no other robots in the opposite waiting area and the passing order is first; and
obtaining a priority traveling direction corresponding to the transition area and a target traveling direction of the target robot when the determination result is that there are other robots in the opposite waiting area, and determining that the target robot does not need to wait when the target traveling direction is with the same as the priority traveling direction and the passing order is first.

18. The method according to claim 15, wherein the number of robots in parallel is at least two, and the method further comprises:
obtaining, when the target robot is located in a target waiting area, a determination result of whether there are other robots in an opposite waiting area based on the position information of each other robot;
when the determination result is that there are no other robots in the opposite waiting area, taking the number of robots in parallel as a target number of robots in a parallel group in the target waiting area, where in the parallel group refers to a group of robots traveling in parallel;
when the determination result is that there are other robots in the opposite waiting area, obtaining a priority traveling direction corresponding to the transition area and a target traveling direction of the target robot, and determining the target number of robots in the parallel group in the target waiting area based on the priority traveling direction, the target traveling direction and the number of robots in parallel;
determining a passing order of a target parallel group to which the target robot belongs in the target waiting area based on the target number of robots; and
controlling the present door corresponding to the target robot to be opened and passing through the present door based on the number of robots in parallel and the position information of each of the other robots in the transition area, when it is determined that the target robot does not need to wait based on the passing order.

19. The method according to claim 15, wherein the number of robots in parallel is one, and controlling the present door corresponding to the target robot to be opened and passing through the present door based on the number of robots in parallel and the position information of each other robot in the transition area comprises:
obtaining target position information of the target robot;
determining a present transition sub-area, a present door and a reference door corresponding to the target robot based on the target position information and installation position information of each door in the multiple levels of doors, the present transition sub-area being the first transition sub-area to be passed through by the target robot, the present door being the first door to be passed through by the target robot, and the reference door being the second door to be passed through by the target robot;
determining that there is no other robot in the present transition sub-area based on the position information of each other robot; and
obtaining a state of the reference door, and when the state of the reference door is closed, controlling the present door to be opened and passing through the present door.

20. The method according to claim 15, wherein the number of robots in parallel is at least two, the target robot is an active robot, the active robot being configured to control the present door to be opened or closed, and controlling the present door corresponding to the target robot to be opened and passing through the present door based on the number of robots in parallel and position information of each other robot in the transition area comprises:
obtaining a target traveling direction and target position information of the target robot;
determining a present transition sub-area, a present door and a reference door corresponding to the target robot based on the target position information and the installation position information of each door in the multiple levels of doors, the present transition sub-area being the first transition sub-area to be passed through by the target robot, the present door being the first door to be passed through by the target robot, and the reference door being the second door to be passed through by the target robot;
determining that there is no other robot with the same traveling direction as the target traveling direction in the present transition sub-area, based on a traveling direction and position information of each other robot, and the target traveling direction; and
obtaining a state of the reference door, and when the state of the reference door is closed, controlling the present door to be opened and passing through the present door.

21. The method according to claim 20, wherein the method further comprises:
obtaining updated position information and updated traveling direction of each other robot when the target robot passing through the present door;
determining that the other robots in the target parallel group to which the target robot belongs are located in the present transition sub-area based on the updated position information of each of the other robots;
determining that there is no other robot in the present transition sub-area traveling in a direction opposite to the target traveling direction based on the updated position information and the updated traveling direction of each of the other robots; and
controlling the present door to be closed.

22. A robot, comprising a memory and a processor, wherein the memory stores a computer program, and the processor, when executing the computer program, is configured to perform a robot traversal method, and the robot traversal method comprises:
determining, when the robot travels to a transition area, a present door corresponding to the target robot in the transition area; and
controlling the present door to be opened and passing through the present door.
